(19) United States
(12) Patent Application Publication
(10) Pub. No.: US 2021/0250186 A1
(43) Pub. Date: Aug. 12, 2021

(54) SECURITY MANAGEMENT FOR EDGE PROXIES ON AN INTER-NETWORK INTERFACE IN A COMMUNICATION SYSTEM

(71) Applicant: Nokia Technologies Oy, Espoo (FI)

(72) Inventors: Nagendra S Bykampadi, Bangalore (IN); Anja Jerichow, Grafing bei München (DE); Suresh Nair, Whippany, NJ (US)

(21) Appl. No.: 17/053,591

(22) PCT Filed: May 7, 2019
(86) PCT No.: PCT/FI2019/050355

§ 371 Date: Nov. 6, 2020

(30) Foreign Application Priority Data
May 9, 2018 (IN) 201841017478

(51) Int. Cl. H04L 9/32; H04W 12/069; H04W 12/50; H04L 29/08

(52) U.S. Cl. CPC H04L 9/3273; H04W 12/069; H04L 67/2876; H04L 67/141; H04W 12/50

(57) ABSTRACT

In a communication system comprising a first network operatively coupled to a second network, wherein the first network comprises a first security edge protection proxy element operatively coupled to a second security edge protection proxy element of the second network, one of the first and second security edge protection proxy elements initiates a mutual authentication procedure with the other of the first and second security edge protection proxy elements. The one of the first and second security edge protection proxy elements exchanges credentials with the other of the first and second security edge protection proxy elements, wherein a secure channel is established between the first and second security edge protection proxy elements upon verification of the credentials.

### FIELD

The field relates generally to communication systems, and more particularly, but not exclusively, to security management within such systems.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point referred to as a gNB in a 5G network. The access point (e.g., gNB) is illustratively part of an access network of the communication system. For example, in a 5G network, the access network is referred to as a 5G System and is described in 5G Technical Specification (TS) 23.501, V15.0.0, entitled “Technical Specification Group Services and System Aspects; System Architecture for the 5G System,” the disclosure of which is incorporated by reference herein in its entirety. In general, the access point (e.g., gNB) provides access for the UE to a core network (CN), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, V0.7.0, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. However, due to continuing attempts to improve the architectures and protocols associated with a 5G network in order to increase network efficiency and/or subscriber convenience, security management issues can present a significant challenge.

### SUMMARY

Illustrative embodiments provide improved techniques for security management in communication systems.

For example, in one illustrative embodiment, a method comprises the following step. In a communication system comprising a first network operatively coupled to a second network, wherein the first network comprises a first security edge protection proxy element operatively coupled to a second security edge protection proxy element of the second network, one of the first and second security edge protection proxy elements initiates a mutual authentication procedure with the other of the first and second security edge protection proxy elements. The one of the first and second security edge protection proxy elements exchanges credentials with the other of the first and second security edge protection proxy elements, wherein a secure channel is established between the first and second security edge protection proxy elements upon verification of the credentials.

In further embodiments, upon establishment of the secure channel, the one of the first and second security edge protection proxy elements exchanges one or more parameters with the other of the first and second security edge protection proxy elements over the secure channel. The one or more parameters may comprise one or more configuration parameters and/or one or more security parameters. The one of the first and second security edge protection proxy elements stores the one or more parameters.

Further illustrative embodiments are provided in the form of non-transitory computer-readable storage medium having embodied therein executable program code that when executed by a processor causes the processor to perform the above steps. Still further illustrative embodiments comprise apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments may be implemented.

FIG. 2 illustrates network elements/functions for providing security management with which one or more illustrative embodiments may be implemented.

FIG. 3 illustrates a communication system architecture with security edge protection proxies between a visited network and a home network with which one or more illustrative embodiments may be implemented.

FIG. 4 illustrates a methodology for mutual authentication and establishment of a secure channel between two security edge protection proxies, according to an illustrative embodiment.

FIG. 5 illustrates a methodology for exchange of parameters over a secure channel established between two security edge protection proxies, according to an illustrative embodiment.

### DETAILED DESCRIPTION

Embodiments will be illustrated herein in conjunction with example communication systems and associated techniques for providing security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) may provide further explanation of network elements/functions and/or operations that may interact with parts of the inventive solutions, e.g., the above-referenced 3GPP TS 23.501 and 3GPP TS 33.501. Other 3GPP TS/TR documents may provide other conventional details that one of ordinary skill in the art will realize. However, while well-suited for 5G-related 3GPP standards, embodiments are not necessarily intended to be limited to any particular standards.

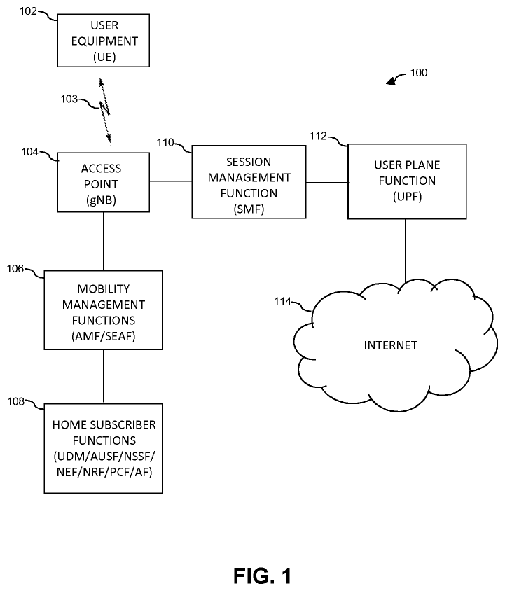

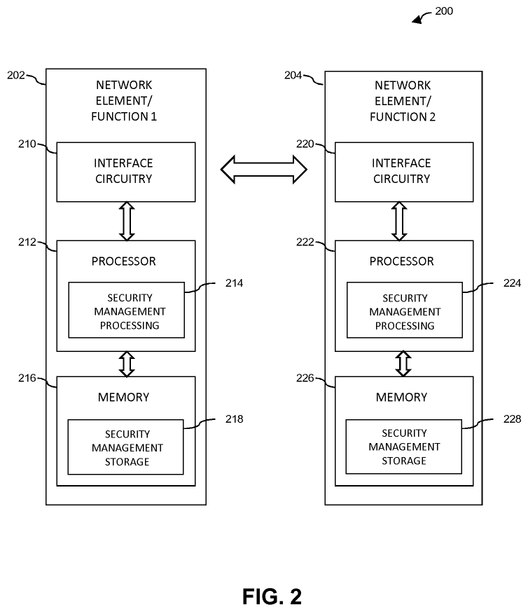

Illustrative embodiments are related to security management associated with the Service-Based Architecture (SBA) for 5G networks. Prior to describing such illustrative embodiments, a general description of main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used to implement some or all of the main functions represented. Also, it is to be understood that not all functions of a 5G network are depicted in FIG. 1. Rather, functions that facilitate an explanation of illustrative embodiments are represented. Subsequent figures may depict some additional elements/functions.

Accordingly, as shown, communication system 100 comprises user equipment (UE) 102 that communicates via an air interface 103 with an access point (gNB) 104. The UE 102 may be a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the permanent subscription identifier and its related key, which are used to identify and authenticate subscribers to access networks. The ME is the user-independent part of the UE and contains terminal equipment (TE) functions and various mobile termination (MT) functions.

Note that, in one example, the permanent subscription identifier is an International Mobile Subscriber Identity (IMSI) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI).

The access point 104 is illustratively part of an access network of the communication system 100. Such an access network may comprise, for example, a 5G System having a plurality of base stations and one or more associated radio network control functions. The base stations and radio network control functions may be logically separate entities, but in a given embodiment may be implemented in the same physical network element, such as, for example, a base station router or femto cellular access point.

The access point 104 in this illustrative embodiment is operatively coupled to mobility management functions 106. In a 5G network, the mobility management function is implemented by an Access and Mobility Management Function (AMF). A Security

Anchor Function (SEAF) can also be implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF may also be referred to herein, more generally, as an access and mobility management entity.

The AMF 106 in this illustrative embodiment is operatively coupled to home subscriber functions 108, i.e., one or more functions that are resident in the home network of the subscriber. As shown, some of these functions include the Unified Data Management (UDM) function, as well as an Authentication Server Function (AUSF). The AUSF and UDM (separately or collectively) may also be referred to herein, more generally, as an authentication entity. In addition, home subscriber functions may include, but are not limited to, Network Slice Selection Function (NSSF), Network Exposure Function (NEF), Network Repository Function (NRF), Policy Control Function (PCF), and Application Function (AF).

The access point 104 is also operatively coupled to a serving gateway function, i.e., Session Management Function (SMF) 110, which is operatively coupled to a User Plane Function (UPF) 112. UPF 112 is operatively coupled to a Packet Data Network, e.g., Internet 114. Further typical operations and functions of such network elements are not described here since they are not the focus of the illustrative embodiments and may be found in appropriate 3GPP 5G documentation.

It is to be appreciated that this particular arrangement of system elements is an example only, and other types and arrangements of additional or alternative elements can be used to implement a communication system in other embodiments. For example, in other embodiments, the system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of network function (NF) sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104.

FIG. 2 is a block diagram of network elements/functions for providing security management in an illustrative embodiment. System 200 is shown comprising a first network element/function 202 and a second network element/function 204. It is to be appreciated that the network elements/functions 202 and 204 represent any network elements/functions that are configured to provide security management and other techniques described herein, for example, but not limited to, AMF, SERF, UDM, AUSF, NSSF, NEF, NRF, PCF and AF. Further, one or both of the first network element/function 202 and the second network element/function 204 may also represent a Security Edge Protection Proxy (SEPP), which will be described in further detail below.

The network element/function 202 comprises a processor 212 coupled to a memory 216 and interface circuitry 210. The processor 212 of the network element/function 202 includes a security management processing module 214 that may be implemented at least in part in the form of software executed by the processor. The processing module 214 performs security management described in conjunction with subsequent figures and otherwise herein. The memory 216 of the network element/function 202 includes a security management storage module 218 that stores data generated or otherwise used during security management operations.

The network element/function 204 comprises a processor 222 coupled to a memory 226 and interface circuitry 220. The processor 222 of the network element/function 204 includes a security management processing module 224 that may be implemented at least in part in the form of software executed by the processor 222. The processing module 224 performs security management described in conjunction with subsequent figures and otherwise herein. The memory 226 of the network element/function 204 includes a security management storage module 228 that stores data generated or otherwise used during security management operations.

The processors 212 and 222 of the respective network elements/functions 202 and 204 may comprise, for example, microprocessors, application-specific integrated circuits (ASICs), field programmable gate arrays (FPGAs), digital signal processors (DSPs) or other types of processing devices or integrated circuits, as well as portions or combinations of such elements. Such integrated circuit devices, as well as portions or combinations thereof, are examples of “circuitry” as that term is used herein. A wide variety of other arrangements of hardware and associated software or firmware may be used in implementing the illustrative embodiments.

The memories 216 and 226 of the respective network elements/functions 202 and 204 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 or 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

The memory 216 or 226 may more particularly comprise, for example, an electronic random access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 of the respective network elements/functions 202 and 204 illustratively comprise transceivers or other communication hardware or firmware that allows the associated system elements to communicate with one another in the manner described herein.

It is apparent from FIG. 2 that network element/function 202 is configured for communication with network element/function 204 and vice-versa via their respective interface circuitries 210 and 220. This communication involves network element/function 202 sending data to the network element/function 204, and the network element/function 204 sending data to the network element/function 202. However, in alternative embodiments, other network elements may be operatively coupled between the network elements/functions 202 and 204. The term “data” as used herein is intended to be construed broadly, so as to encompass any type of information that may be sent between network elements/functions (as well as between user equipment and a core network) including, but not limited to, messages, identifiers, keys, indicators, user data, control data, etc.

It is to be appreciated that the particular arrangement of components shown in FIG. 2 is an example only, and numerous alternative configurations may be used in other embodiments. For example, any given network element/function can be configured to incorporate additional or alternative components and to support other communication protocols.

Other system elements such as UE 102 and gNB 104 may each also be configured to include components such as a processor, memory and network interface. These elements need not be implemented on separate stand-alone processing platforms, but could instead, for example, represent different functional portions of a single common processing platform.

Given the general concepts described above, illustrative embodiments that address certain security management issues will now be described. More particularly, illustrative embodiments provide security management techniques for 5G systems. The architecture for 5G systems is currently being standardized in 3GPP. As mentioned above, the 3GPP TS 23.501 defines the 5G system architecture as service-based, e.g., Service-Based Architecture (SBA).

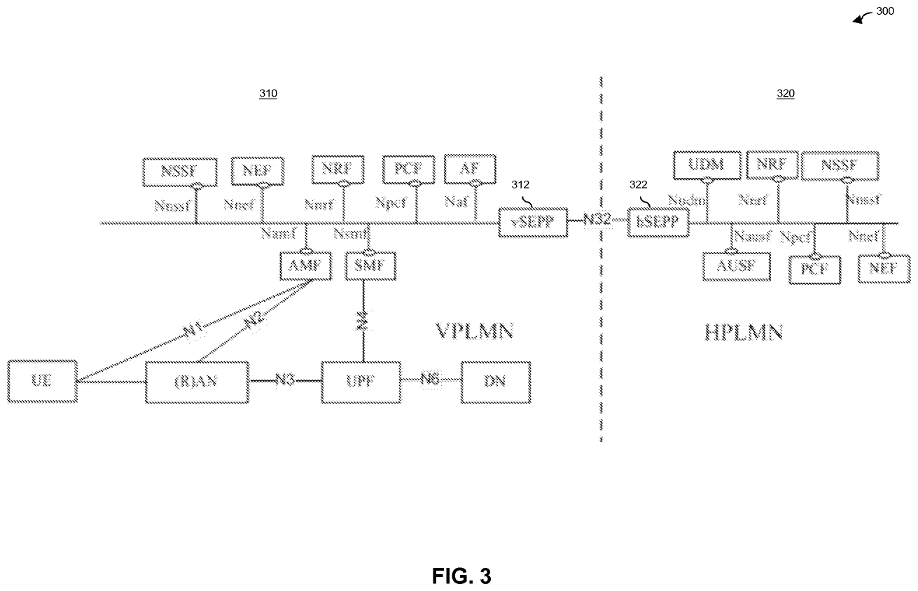

FIG. 3 depicts a 5G architecture in a configuration comprising a visited public land mobile network (VPLMN) 310 operatively coupled to a home public land mobile network (HPLMN) 320. More particularly, FIG. 3 illustrates the presence of a Security Edge Protection Proxy (SEPP) at the edge of each PLMN, i.e., vSEPP 312 in VPLMN 310 and hSEPP 322 in HPLMN 320. It is to be appreciated that the various network functions shown in the VPLMN 310 and the HPLMN 320 are known and described in detail in various 5G specifications such as, but not limited to, the above-referenced TS 23.501 and TS 33.501.

As mentioned above, in 5G, SBA is introduced to model services as network functions (NFs) that communicate with each other using Restful application programming interfaces (Representational State Transfer APIs). In the scenario where the two communicating NFs are in two different PLMNs (e.g., VPLMN 310 and HPLMN 320), communication happens over a roaming inter-network interface (N32) between the two participating PLMNs.

To protect NF specific content in the messages that are sent over the roaming inter-network interface, 5G introduces the SEPP as the entity residing at the perimeter of the PLMN network to protect the PLMN from outside traffic and additionally implements transport layer security and application layer security for all the data and signalling exchanged between two inter-network network functions at the service layer. For example, the SEPP performs security management functions on information elements (IE) in HyperText Transport Protocol (HTTP) messages before the messages are sent externally over the roaming N32 interface.

Application layer security involves protecting information sent in various parts of the HTTP message including, but not limited to, HTTP Request/Response Line, HTTP header and HTTP Payload. However, some parts of this message may need to be modified by intermediaries (Inter-network Packet eXchange (IPX) providers not expressly shown in FIG. 3) between the two SEPPs.

Thus, in 5G SBA, the PLMN operator deploys a SEPP at the edge of its network to interoperate and obtain services from network functions in its roaming partner networks. The SEPP interfaces with one or more other SEPPs in one or more other networks over the N32 interface. As an edge proxy, the SEPP implements application layer security to protect HTTP messages exchanged between a network function in its network and another network function in the roaming partner network.

Proposals for security management functions for SEPPs have been made. For example, a mechanism has been proposed for signaling based remote provisioning and update of the protection information (e.g., protection file) in the SEPP of the visited network. The hSEPP uses its established N32 signaling channel with the vSEPP to forward these policies to the vSEPP. Further, a mechanism has been proposed to protect HTTP messages exchanged between two network functions in different networks, using transport layer security (TLS) based on a TLS protocol. Still further, a mechanism has been proposed to protect HTTP messages exchanged between two network functions in different networks, using application layer security (ALS) mechanism based on Java Script Object Notation (JSON) data protecting mechanisms such as JSON Web Signature (JWS), JSON Web Encryption (JWE), etc.

Before the two participating SEPPs (e.g., vSEPP 312 and hSEPP 322) can exchange protected HTTP messages, it is realized herein that it is important that the SEPPs first mutually authenticate each other and then exchange a set of parameters over a secure connection between the two entities. For example, the set of parameters that the two SEPPs agree on include capability exchange, cipher suites to use for protection of HTTP message payload, protection policies that indicate which parameters to encrypt in each HTTP message, and so on. Such parameters therefore comprise one or more configuration parameters and/or one or more security parameters. Further examples of such parameters will be described below.

Illustrative embodiments provide a framework in the form of a handshake procedure that enables SEPPs to set up a secure mutually authenticated connection (secure channel) and exchange the set of parameters beneficial for setting up security of HTTP messages. In addition, the SEPPs also exchange configuration information such as a provisioning file, etc. In illustrative embodiments, this procedure therefore becomes a prerequisite before the two SEPPs are ready to implement TLS or ALS as mentioned above. As compared with the above-mentioned proposed mechanism for remote provisioning of protection policies, illustrative embodiments described herein exchange a protection policy during the initial handshake between the two SEPPs whereas the above-mentioned proposed mechanism updates remote SEPPs with a protection policy dynamically whenever the policy gets updated/revised in the SEPP of the home PLMN.

More particularly, one or more illustrative embodiments implement an initial handshake procedure between two participating SEPPs as follows:

a) In one embodiment, the SEPP in the home PLMN initiates a mutual authentication procedure with a roaming partner SEPP in the visiting PLMN. In an alternative embodiment, the SEPP in the visited PLMN may also trigger the mutual authentication procedure.

b) The two SEPPs exchange their credentials and mutually authenticate each other. For example, credentials could be in the form of public key infrastructure (PKI) certificates. When certificates are used, it is assumed that the two participating SEPPs are in possession of the relevant root Certificate Authority (CA) certificates that establish the validity of SEPP certificates to its peer on the other side.

c) Once the two SEPPs mutually authenticate each other and establish a secure connection between each other, they may exchange the following parameters with each other:

1. Confidentiality protection scheme—symmetric encryption based on shared secret or asymmetric encryption based on public/private key pair.

2. Integrity protection scheme—symmetric key based (message authentication code or MAC) or digital signature based on public/private key pair.

3. Cipher suites for use in HTTP payload protection—algorithm used for encryption and integrity protection.

4. Diffie Hellman parameters to set up a shared secret, if needed.

5. Protection policy that captures home operator's guidance on how to protect individual parameters in HTTP messages addressed to it.

6. An implicit or explicit activation time to establish ALS security over the N32 interface using the parameters, e.g., immediately after the handshake between the two SEPPs or at an indicated time later (i.e., any time parameter for activation of ALS security).

d) Once the parameters are exchanged, the two SEPPs terminate the secure connection.

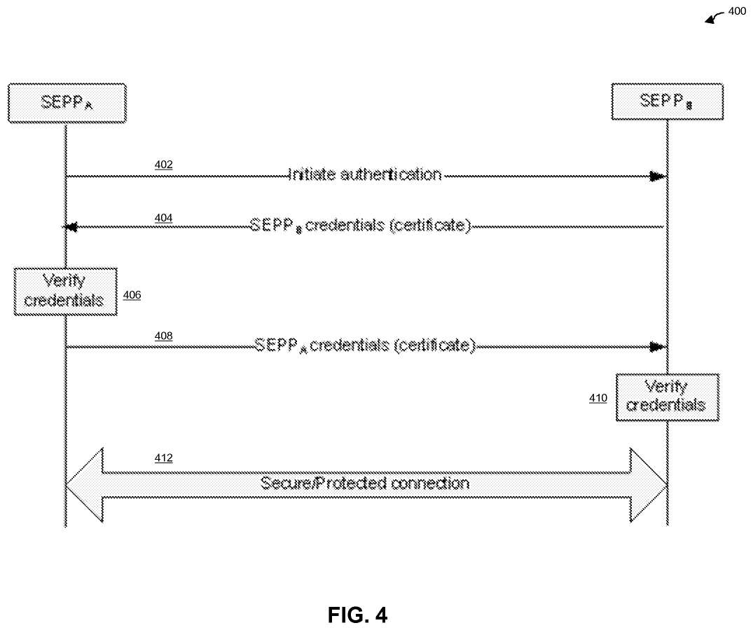

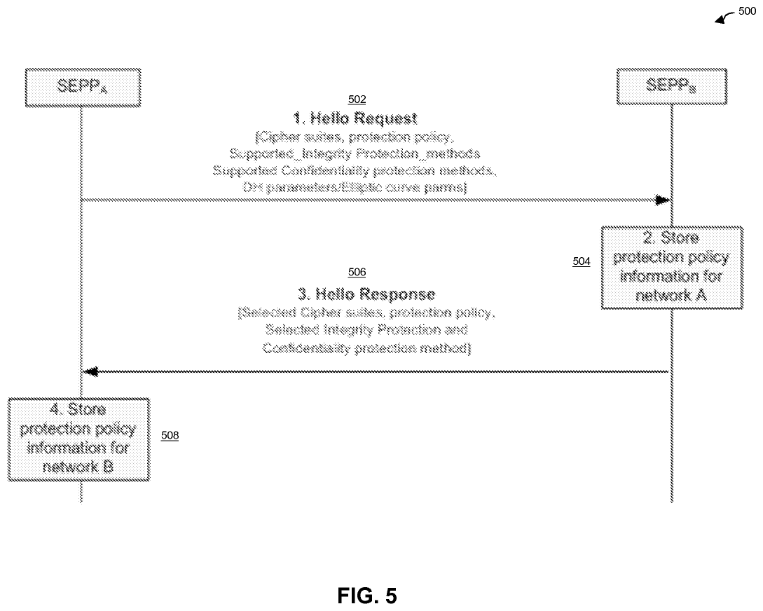

At the end of the initial handshake procedure the two SEPPs have all the information needed to implement ALS over the N32 interface. The above-described handshake procedure is further illustrated below in the context of FIGS. 4 and 5.

Note that FIG. 4 illustrates the part of the handshake procedure that performs mutual authentication and establishment of a secure channel (secure/protected connection) between two SEPPs. FIG. 5 illustrates the part of the handshake procedure that performs exchange of critical parameters over the secure channel between the two SEPPs. The two parts of the handshake procedure will now be described below.

### Mutual Authentication and Establishment of a Secure Channel Between Two SEPPs

As shown in methodology 400 of FIG. 4, mutual authentication is performed between two SEPPs belonging to two roaming partners. The two SEPPs are denoted as SEPP_{A} and SEPP_{B}. More particularly, SEPP_{A} belonging to network A triggers (initiates) authentication with SEPP_{B} of network B in step 402. In one embodiment, SEPP_{A} belongs to home PLMN (e.g., hSEPP 322 in HPLMN 320 in FIG. 3) and SEPP_{B} belongs to visited PLMN (e.g., vSEPP 312 in VPLMN 310 in FIG. 3). In an alternate embodiment, SEPP_{A} is vSEPP 312 and belongs to VPLMN 310 and SEPP_{B} is hSEPP 322 and belongs to HPLMN 320.

The two SEPPs exchange their credentials. Each SEPP verifies the credential of the partner SEPP. More particularly, in this example, SEPP_{B} sends its credentials to SEPP_{A} in step 404. As mentioned above, the credentials may comprise a certificate, e.g., CA certified PKI certificate. SEPP_{A} verifies the received credentials in step 406. In step 408, SEPP_{A} sends its credentials (e.g., CA certified PKI certificate) to SEPP_{B}. SEPP_{B} verifies the received credentials in step 410. It is assumed that the two SEPPs are configured with necessary mechanisms (e.g., root CA certificates, pre-shared keys, etc) to verify each other's credentials.

At the end of mutual authentication (credential exchange and verification), a secure channel (protected connection) is established between SEPP_{A} and SEPP_{B}, as shown in step 412. This secure channel provides confidentiality protection, integrity protection and replay protection for all traffic exchanged between the two SEPPs.

A standardized mechanism such as TLS (at the transport layer) and Internet Protocol Security or IPSec (at the network layer) may also be used by the two SEPPs to authenticate each other and set up a protected connection between the two entities.

### Exchange of Critical Parameters Over the Secure Channel Between Two SEPPs

Once a secure connection is set up as in FIG. 4, the two SEPPs exchange configuration and security related parameters that are used by the SEPPs to protect service layer messages (HTTP messages) exchanged between two network functions in their respective networks. Methodology 500 in FIG. 5 illustrates the parameter exchange.

In illustrative embodiments, the following configuration parameters may be exchanged between the two SEPPs:

Protection policy—Protection policy captures home operator's guidance on how to protect individual parameters (information) in HTTP messages addressed to it. This policy indicates, for example, which parameters require encryption in the HTTP message.

Other embodiments may provide that the protection policy contains alternative or additional information. The format and content of the protection policy is not intended to limit the scope of the invention.

In illustrative embodiments, the following security related parameters may be exchanged between the two SEPPs:

a. Cipher suites for confidentiality and integrity protection when ALS security is used to protect HTTP messages between them.
b. Supported confidentiality protection methods—symmetric encryption, asymmetric encryption.
c. Supported integrity protection methods—MAC-based, digital signature-based.
d. An implicit or explicit activation time to establish ALS security over the N32 interface using the parameters, e.g., immediately after the handshake between the two SEPPs or at an indicated time later.
e. Diffie Hellman (DH) parameters or Elliptic Curve Diffie Hellman (ECDH) parameters—needed if shared secret key is required to be generated for confidentiality or/and integrity protection.

It is to be appreciated that parameters in (e) are needed when a shared secret is used for symmetric encryption or MAC based integrity protection.

Thus, in step 502 of FIG. 5, SEPP_{A} initiates a Hello Request message to SEPP_{B} with all or some of the parameters listed above, as well as others if needed depending on the selected security protocols. SEPP_{B} stores the protection policy information for network A, and other information as needed, in step 504. In step 506, SEPP_{B} responds with a Hello Response message to SEPP_{A} with its configuration and security parameters. SEPP_{A} stores the protection policy information for network B, and other information as needed, in step 508.

At the end of the procedure, the two SEPPs have all the information needed to protect HTTP messages between two network functions in their respective networks either immediately following the handshake procedure or to begin at a specified time (i.e., any time parameter for activation of ALS security).

It is to be appreciated that, in one or more illustrative embodiments, the two SEPPs may discover each other based on one or more procedures including, but not limited to, Dynamic Host Configuration Protocol (DHCP) or local configuration and uniform resource identifier (URI)-enabled Name Authority Pointer (U-NAPTR) resource records in a Domain Name System (DNS), FQDN configuration in a local database, etc.

It should therefore again be emphasized that the various embodiments described herein are presented by way of illustrative example only and should not be construed as limiting the scope of the claims. For example, alternative embodiments can utilize different communication system configurations, user equipment configurations, base station configurations, key pair provisioning and usage processes, messaging protocols and message formats than those described above in the context of the illustrative embodiments. These and numerous other alternative embodiments within the scope of the appended claims will be readily apparent to those skilled in the art.

1-20. (canceled)

21. An apparatus comprising:
at least one processor coupled to a memory and configured to implement a first security edge protection proxy element of a first network in a communication system, the first security edge protection proxy element being operatively coupled to a second security edge protection proxy element of a second network coupled to the first network;
the first security edge protection proxy element being configured:
to receive a first message from a first network function in the first network, the first message being addressed to a second network function in the second network, the first message comprising one of a request line and a response line comprising a uniform resource identifier (URI) having a plurality of elements; and
to form a second message comprising an encrypted portion and an integrity protected portion, the encrypted portion comprising an encryption of at least a subset of the plurality of elements of the URI, the integrity protected portion comprising a structured representation of the URI wherein instances of elements in the subset are replaced with references to the encrypted portion.

22. The apparatus of claim 21, wherein the first message comprises one of a hypertext transfer protocol (HTTP) request and an HTTP response.

23. The apparatus of claim 21, wherein the structured representation in the second message of the URI in the first message comprises a JavaScript Object Notation (JSON) structure.

24. The apparatus of claim 21, wherein the URI comprises a path component and the structured representation of the URI comprises an array of structured objects comprising substrings of the path component.

25. The apparatus of claim 24, wherein the structured objects of the array comprise one or more first strings representing one or more path segments in the URI and one or more second strings representing variable names each related to one or more of the path segments represented in one of the first strings.

26. The apparatus of claim 25, wherein the structured representation of the URI in the integrity protected portion of the second message omits at least a given one of the second strings to hide a URI variable.

27. The apparatus of claim 25, wherein the structured representation of the URI in the integrity protected portion of the second message replaces at least a given one of the first strings with a reference to an entry in the encrypted portion of the second message containing the given first string.

28. The apparatus of claim 21, wherein the URI comprises a query component and the structured representation of the URI comprises an array of structured objects comprising substrings of the query component.

29. The apparatus of claim 28, wherein the structured objects of the array comprise one or more pairs of strings, each pair of strings comprising a first string representing a query parameter name and a second string representing a query parameter value.

30. The apparatus of claim 29, wherein the structured representation of the URI in the integrity protected portion of the second message replaces at least a given one of the second strings with a reference to an entry in the encrypted portion of the second message containing the given second string.

31. The apparatus of claim 29, wherein the structured representation of the URI in the integrity protected portion of the second message replaces at least a given one of the pairs of strings with a reference to an entry in the encrypted portion of the second message containing the given pair of strings.

32. The apparatus of claim 28, wherein the structured objects of the array comprise one or more strings each representing a query parameter name for which there is no associated query parameter value.

33. The apparatus of claim 32, wherein the structured representation of the URI in the integrity protected portion of the second message replaces at least a given one of the strings with a reference to an entry in the encrypted portion of the second message containing the given string.

34. The apparatus of claim 21, wherein the URI comprises an opaque query component, and the structured representation of the URI in the integrity protected portion of the second message replaces the opaque query component with a reference to an entry in the encrypted portion of the second message containing the opaque query component.

35. The apparatus of claim 21, wherein the URI comprises a query component, and the structured representation of the URI in the integrity protected portion of the second message:
replaces an opaque part of the query component with a first reference to a first entry in the encrypted portion of the second message containing the opaque part of the query component; and
replaces at least a given substring of the query component with at least a second reference to at least a second entry in the encrypted portion of the second message containing the given substring, the given substring comprising one of: a given pair of strings comprising a first string representing a query parameter name and a second string representing a query parameter value; the second string of the given pair of strings; and a given flag string representing a query parameter name for which there is no associated query parameter value.

36. A method comprising:
in a communication system comprising a first network operatively coupled to a second network wherein a first security edge protection proxy element of the first network is operatively coupled to a second security edge protection proxy element of the second network;
receiving, at the first security edge protection proxy element, a first message from a first network function in the first network, the first message being addressed to a second network function in the second network, the first message comprising one of a request line and a response line comprising a uniform resource identifier (URI) having a plurality of elements; and
forming, at the first security edge protection proxy element, a second message comprising an encrypted portion and an integrity protected portion, the encrypted portion comprising an encryption of at least a subset of the plurality of elements of the URI, the integrity protected portion comprising a structured representation of the URI wherein instances of elements in the subset are replaced with references to the encrypted portion.

37. The method of claim 36, wherein the URI comprises a path component and the structured representation of the URI comprises an array of structured objects comprising substrings of the path component.

38. The method of claim 36, wherein the URI comprises a query component and the structured representation of the URI comprises an array of structured objects comprising substrings of the query component.

39. An article of manufacture comprising a non-transitory computer-readable storage medium having embodied therein executable program code that when executed by a processor causes the processor to perform the steps of:
in a communication system comprising a first network operatively coupled to a second network wherein a first security edge protection proxy element of the first network is operatively coupled to a second security edge protection proxy element of the second network;
receiving, at the first security edge protection proxy element, a first message from a first network function in the first network, the first message being addressed to a second network function in the second network, the first message comprising one of a request line and a response line comprising a uniform resource identifier (URI) having a plurality of elements; and
forming, at the first security edge protection proxy element, a second message comprising an encrypted portion and an integrity protected portion, the encrypted portion comprising an encryption of at least a subset of the plurality of elements of the URI, the integrity protected portion comprising a structured representation of the URI wherein instances of elements in the subset are replaced with references to the encrypted portion.
